(19) United States
(12) Patent Application Publication
(10) Pub. No.: US 2011/0108643 A1
(43) Pub. Date: May 12, 2011

(54) ROLLER MILL WITH SEALING GAS IMPINGEMENT

(75) Inventors: Thomas Krause, Oberhausen (DE); Werner Bischoff, Oberhausen (DE); Tieu Le Van, Oberhausen (DE)

(73) Assignee: Hitachi Power Europe GmbH, Duisburg (DE)

(21) Appl. No.: 12/990,966

(22) PCT Filed: Mar. 11, 2009
(86) PCT No.: PCT/EP2009/001720

§ 371 Date: Jan. 21, 2011

(30) Foreign Application Priority Data
May 8, 2008 (DE) 10 2008 022 847.8
May 8, 2008 (DE) 20 2008 006 372.8

(51) Int. Cl. B02C 4/00

(52) U.S. Cl. 241/18; 241/68; 241/101.2

(57) ABSTRACT

In a roller mill (1, 46), in particular a coal mill, comprising a mill housing (2) comprising a rotating grinding table (4) with grinding tools located thereon, in particular grinding rolls (5), a grind material feed (9), a classifier (8), at least one grind material exit (11), at least one sealing gas seal (14, 16, 17, 19) that seals off the mill interior (31) from the outside atmosphere in the area of moving mill elements and a carrier gas feed (12), wherein the roller mill (1, 46) can be operated in pressurized mode, a solution is to be provided that facilitates the use of recirculated stack gas as sealing gas without significantly affecting the mill environment. This is accomplished in that at least the at least one sealing gas seal (14, 16) comprises a first sealing chamber (22a, 22b, 22c) and a second sealing chamber (23a, 23b, 23c), wherein the first sealing chamber (22a, 23a, 22b, 22c) is acted upon by a sealing gas having a sealing gas pressure that is greater than the mill pressure in the mill interior (31) during milling operation and the second sealing chamber (23a, 23b, 23c) is acted upon by a sealing gas having a sealing gas pressure that is lower than the sealing gas of the first sealing chamber (22a, 22b, 22c) and wherein a take-off, in particular a line (24a, 24b, 24c), is disposed at the second sealing chamber (23a, 23b, 23c), said take-off discharging the sealing gas from the second sealing chamber (23a, 23b, 23c).

The invention is aimed at a roller mill, in particular coal mill, comprising a mill housing with a rotating grinding table having grinding tools, in particular grinding rollers, lying on it, with a grinding stock feed, with a sifter, with a grinding stock discharge, with at least one sealing gas seal sealing off the mill interior in the region of movable mill elements with respect to the outside atmosphere, and with a carrier gas feed, the roller mill being capable of being operated in pressurized mode. The invention is aimed, furthermore, at a method for operating such a roller mill.

Roller mills are used, inter alia, in the sector of coal-fired power plants for grinding the coal to be burnt in the combustion chamber of a steam generator. The basic set-up of roller mills or else vertical mills comprises a mill housing with a rotating grinding table which is arranged therein and onto which grinding tools lying on it are pressed on account of their own weight, but also as a result of the application of additional spring force or of hydraulic force by means of hydraulic cylinders. These grinding tools may be balls or else cylindrical, conical or crowned rollers. The material feed for the hard coal or lignite to be ground in the case considered here takes place by means of a chute from above or obliquely from above or else through a central coal feed pipe as the grinding stock feed onto the middle of the grinding table. When the mill is in operation, the grinding stock which is fed is moved toward the table margin as a result of the centrifugal forces taking effect. On the way there, the grinding stock is picked up by the grinding tools and rolled over once or more than once. It is comminuted in the process. This gives rise to a mixture of coarsely and finely comminuted material. The milling or grinding process is set up such that an optimized grinding bed, that is to say a layer of ground grinding stock, is formed on the grinding table. Via a carrier gas feed, for example a nozzle ring at the margin of the grinding table or of the grinding bowl, a carrier gas, usually air, is injected into the roller mill. The air stream entering here is directed upward and entrains the lighter, ground-up grinding stock upward to a sifter or separator arranged there inside the mill housing and then discharges the ground grinding stock out of the mill housing via a grinding stock discharge. The sifter or separator serves for the separation of coarse and fine stock. The fine stock is discharged by the carrier gas through the sifter to the grinding stock discharge and then out of the roller mill, while the coarse stock falls downward again onto the grinding table and is ground anew.

In accordance with discussions relating to the environment, “CO₂-free” coal-fired power stations, as they are known, are being developed at the present time. These are operated by means of methods in which, at the end of flue gas purification, CO₂ is separated out of the flue gas and, for example, liquefied and is then delivered to a store. In this regard, it is known to operate coal-fired power stations with CO₂ separation on the basis of what is known as the oxyfuel process. In this method, the nitrogen is extracted from the air upstream of the combustion chamber or upstream of the steam generator boiler by means of an air separation plant, so that virtually pure oxygen is delivered for combustion. In order in the combustion chamber to obtain a temperature level similar to that for combustion of air, in this method about two-thirds of the flue gases have to be recirculated for firing after being cooled. In this case, treated flue gas, but also untreated flue gas, can be recirculated. If it has a sufficiently high flue gas temperature, the recirculation gas (flue gas) can be utilized for the grind-drying of the coal. In this case, the recirculation gas is delivered as carrier gas to the roller mill.

Furthermore, roller mills of this type have various moved or movable mill elements which, when the roller mill is operated in pressurized mode, have to be sealed off against an escape of mill carrier gas out of the mill housing into the outside atmosphere. For this purpose, these mill elements have corresponding seals, and in this case this sealing off may also take place by means of what is known as sealing gas or sealing air, the mill elements then being provided with sealing gas seals sealing off with respect to the outside atmosphere. Such sealing-off sealing gas seals may be arranged in the region of the mounting of the dynamic sifter which, for example, rotates about a central coal entry pipe as center axis, sealing air or sealing gas then being introduced into the gap formed between the outside of the central coal entry pipe and the inside of the rotating sifter, and being blown out into the interior of the mill housing. Another sealing-off sealing gas seal may be formed in the region of the axial guidance of the grinding tools. Appropriate sealing-off sealing gas seals ensure there that no internal air or no carrier gas can escape outward from the mill housing. Sealing-off sealing gas seals may also be provided in the region of the tie rods and in the region of the plinth bottom. Within the framework of the concept of hard coal-fired power stations with CO₂ separation, based on an oxyfuel process, then, replacing the air of the sealing air mass flow by purified and dehumidified CO₂ recirculate has also already been discussed in the paper by A. Kather et al., Steinkohlenkraftwerk mit CO₂-Abtrennung auf Basis des Oxyfuel-Prozesses [Hard coal-fired power station with CO₂ separation based on the oxyfuel process], 38th Power Station Technology Conference 2006. However, the sealing-off sealing air or sealing gas seals are not completely leaktight, and therefore, in such a procedure, assuming a leakage rate of 5% of the sealing gas, approximately 26 t of CO₂ would then escape daily into the surroundings of the mill. Since CO₂ has a higher density than air, it would become enriched in the surroundings of the mills standing on the ground, this being inadmissible for reasons of operating safety. As a possible countermeasure, the mills could be encased, and these spaces could then be provided with suction extraction facilities. However, this leads to a markedly increased outlay in structural and manufacturing terms, with a corresponding increase in the cost of roller mills of this type. If, by contrast, the introduction of atmospheric nitrogen into the process, using normal ambient air as sealing air, is tolerated, this leads to a lowering of the maximum achievable CO₂ concentration by the amount of 3 percentage points in the dry flue gas downstream of the steam generator, with the result that the positive effect provided by the recirculation of the CO₂ flue gas is diminished and correspondingly lower efficiency, as compared with power stations without the introduction of sealing air, is obtained.

The object on which the invention is based, therefore, is to provide a solution which makes it possible to use recirculating flue gas as sealing gas without any significant negative effects on the surroundings of the mill.

In a roller mill of the type initially described, this object is achieved, according to the invention, in that at least the at least one sealing gas seal comprises a first sealing chamber and a second sealing chamber, the first sealing chamber being acted upon with a sealing gas having a sealing gas pressure that is increased in relation to the mill pressure prevailing in the mill interior while the mill is in operation, and the second sealing chamber being acted upon with a sealing gas having a sealing gas pressure that is lower in relation to that of the sealing gas of the first sealing chamber, and a diversion, in particular a line, which conducts the sealing gas out of the second sealing chamber being arranged on the second sealing chamber.

The object is likewise achieved by means of a method for operating a roller mill as claimed in one of claims 1-10, in which recirculated CO₂-containing flue gas, in particular from a coal-fired power station, the combustion chamber of which is supplied according to the oxyfuel process with oxygen, instead of air, for combustion, is fed as sealing gas or a sealing gas constituent to the first sealing chamber and/or to the second sealing chamber and is conducted out of the second sealing chamber.

By virtue of the invention, it is possible to form a sealing-off sealing gas seal which is operated with CO₂-containing recirculated flue gas as sealing gas, but in which the leakage rates can nevertheless be kept so low that the surroundings of the mill are not negatively affected by CO₂-containing gas which emerges. The invention makes it possible to act upon the first sealing chamber with the CO₂-containing flue gas. In this case, the flue gas is expediently fed to the first sealing chamber at a pressure which is designed to be higher than the mill interior pressure. The CO₂-containing sealing gas introduced into the first sealing chamber passes out of the first sealing chamber, at the same time as sealing off the corresponding ventilation paths, and into the mill interior or the interior of the mill element to be sealed off. The CO₂-containing sealing gas likewise enters the flow paths leading outward from the sealing chamber to the outside atmosphere. The second sealing chamber is then arranged, with respect to the first sealing chamber, in a downstream position in these lines or flow paths leading outward, the corresponding flow paths issuing into said second sealing chamber, although there may possibly also be only one flow path. A pressure reduced in relation to the first sealing chamber prevails in the second sealing chamber, in particular a pressure which is also designed to be lower than or equal to the external atmospheric pressure prevails in the second sealing chamber. As a result, in the second sealing chamber, a kind of suction chamber is formed, which, on the one hand, sucks in the CO₂-contaiing sealing gas out of the first sealing chamber in each case. Furthermore, however, air is sucked into the second sealing chamber from the outside via any existing leakage orifices or connections or flow paths. As a result, a sealing gas with a CO₂ concentration that is reduced in relation to the first sealing chamber is formed in the second sealing chamber. Moreover, a line or diversion conducting away the sealing gas or the sealing gas/air mixture is then also arranged or formed on the second sealing chamber, through which line or diversion the sealing gas or sealing gas/air mixture is conducted out of the second sealing chamber in a directed manner and, where appropriate, is intercepted at the end of the latter in a directed manner. This avoids the situation where the sealing gas or sealing gas/air mixture escapes from the second sealing chamber directly into the outside atmosphere in the surroundings of the mill.

Briefly summarized, therefore, the essential aspect of the invention is that a sealing-off sealing gas seal is formed in that a first sealing chamber, into which CO₂-containing sealing gas is introduced in pressurized mode, is present. As a result, the accesses and flow paths from and to the mill interior are sealed off by the sealing gas. The sealing gas forcing its way through leakage orifices or corresponding flow paths outward to the outside of the mill is intercepted with the aid of the second sealing chamber. Furthermore, a lower pressure prevails in the second sealing chamber, as compared with the first sealing chamber, so that the “leakage” sealing gas of the first sealing chamber is also sucked in by the second sealing chamber. Moreover, air is also sucked in from outside by the second sealing chamber, thus preventing the situation where CO₂-containing sealing gas may force its way outward, since outside air is sucked into the second sealing chamber via these leakage flow paths. The sealing gas or sealing gas/air mixture is then conducted out of the second sealing chamber in a directed manner via a line or diversion.

In the simplest instance, therefore, it is necessary merely to have one first sealing chamber acted upon with CO₂-containing sealing gas and having an increased sealing gas pressure, one second sealing chamber having a comparatively lower sealing gas pressure and one diversion arranged on the second sealing chamber and conducting away the sealing gas. With the aid of this design, the situation is prevented where CO₂-containing sealing gas emerges outward into the atmosphere in the region of the sealing gas seal and has a negative effect on the surroundings of the mill. On the other hand, however, it is consequently possible both to recirculate CO₂-containing flue gas into the roller mill as carrier gas and to use it as sealing gas, so that the thereby possible positive influence upon the efficiency of the CO₂ compression of the power station can be utilized for operation according to the oxyfuel process.

Refinements and developments of the invention may be gathered from the respective subclaims.

In this case, designing the sealing gas pressure of the second sealing chamber so that it has a pressure lower than or equal to the atmospheric pressure is advantageous in as much as a sucking-in effect by the second sealing chamber in respect of the surrounding outside air is thereby generated and air is sucked in through any existing leakage orifices or leakage flow paths, with the result that an escape of CO₂-containing sealing gas through these very leakage orifices or leakage flow paths outward is prevented.

It is most especially advantageous to use such a sealing gas seal according to the invention in a roller mill in which the sealing gas of the first sealing chamber and/or of the second sealing chamber is recirculated CO₂-containing flue gas, in particular from a coal-fired power station, the combustion chamber of which is supplied according to the oxyfuel process with oxygen, instead of air, for combustion.

In this case, the sealing gas of the first and/or second sealing chamber may be a CO₂-containing flue gas with an admixed oxygen fraction, the invention likewise providing this.

In order to design the first sealing chamber virtually as a main sealing chamber for sealing off the mill interior and to design the second sealing chamber virtually for sealing off the first sealing chamber with respect to the outside atmosphere, the invention provides, furthermore, for the first sealing chamber to be a first sealing chamber located nearest to the mill interior, and for the second sealing chamber to be a second sealing chamber which is located downstream for sealing gas emerging from the first sealing chamber, is remote from the mill interior with respect to a flow connection to the mill interior and is located nearest to the outside atmosphere.

For sealing off one or more mill elements, the roller mill may have one or more sealing gas seals in the region of the plinth bottom seal and/or in the region of the sifter drive seal and/or in the region of the tie rod seal and/or in the region of the grinding roller seal, and, according to an advantageous refinement of the invention, sealing gas fed to each of these sealing gas seals is recirculated CO₂-containing flue gas from a coal-fired power station operating according to the oxyfuel process.

In this case, a plurality of the sealing gas seals, but, in particular, at least one sealing gas seal, may be equipped with a first and second sealing chamber. In particular, the sealing gas seals in the region of the plinth bottom seal and/or in the region of the sifter drive seal and/or in the region of the grinding roller seal are provided with a first and a second sealing chamber, while it is also perfectly possible for such a sealing gas seal to be formed in the region of the tie rod seal.

The refinement according to the invention of a roller mill is especially advantageous when the roller mill is a component of a coal-fired power plant, in particular of a hard coal-fired power station, operated on the basis of the oxyfuel process with CO₂ separation, the invention likewise providing this.

In this case, it is possible, furthermore, that the carrier gas feed of the mill is also line-connected to the flue gas line for recirculated, preferably purified and dehumidified, CO₂-containing flue gas from a coal-fired power station, the combustion chamber of which is supplied according to the oxyfuel process with oxygen, instead of air, for combustion. The mill is then consequently designed as a roller mill operated overall, both on the carrier gas side and on the sealing gas side, with CO₂-containing recirculating flue gas.

In order, in a roller mill with a static sifter, to seal off, with respect to the outside atmosphere, leakage outlets through leadthroughs, through which shafts for the adjustment of sifter flaps arranged in the mill interior are led through the upper housing cover into the mill interior, the invention provides for covering these leadthroughs with an encasing chamber formed in a casing. In a refinement, therefore, the invention is distinguished, furthermore, in that a casing covering leadthroughs into the mill interior, in particular leadthroughs for shafts, and forming a casing chamber with a connected diversion line is formed in the upper housing cover.

In a refinement of the method according to the invention, there is provision whereby a sealing gas seal in the region of the plinth bottom seal is supplied with 27-33%, a second seal in the gas seal in the region of the sifter drive seal is supplied with 36-44%, a third sealing gas seal in the region of the grinding roller seal is supplied with 21.5-26.5% and a fourth sealing gas seal in the region of the tie rod seal is supplied with 5.5-6.5% of the overall sealing gas mass flow fed to the roller mill.

Furthermore, the method is also distinguished in that the carrier gas feed is preferably supplied with purified and dehumidified CO₂-containing flue gas as mill carrier gas or a mill carrier gas constituent, the flue gas preferably coming from a coal-fired power station, the combustion chamber of which is supplied according to the oxyfuel process with oxygen, instead of air, for combustion.

Finally, according to a refinement of the invention, there is also provision whereby leakage gas emerging from leadthroughs, in particular leadthroughs for shafts, is intercepted and conducted away by means of a casing chamber arranged on the upper housing cover and having a connected diversion line.

The invention is explained in more detail below, by way of example, by means of a drawing in which:

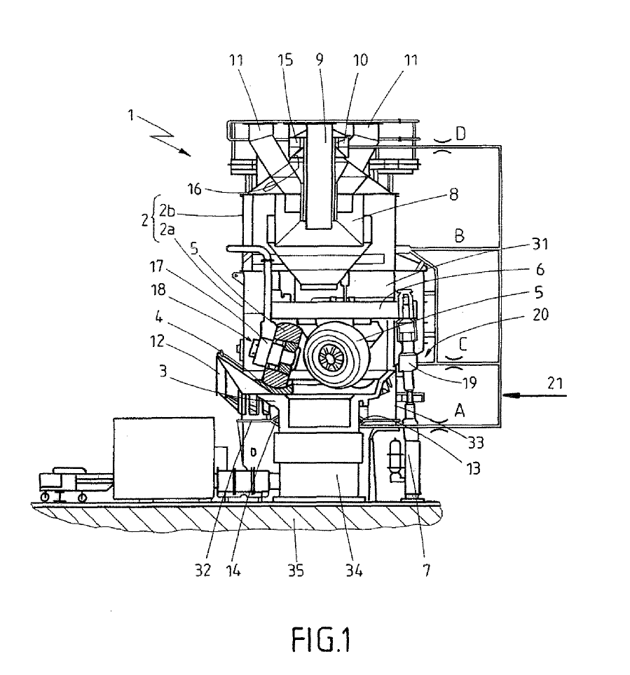

FIG. 1 shows a diagrammatic illustration of a roller mill with a dynamic sifter,

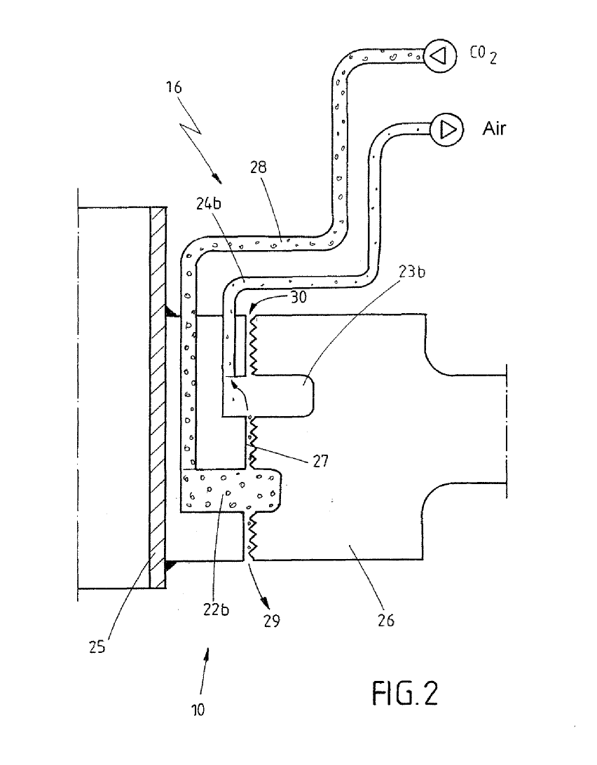

FIG. 2 shows a sealing gas seal in the region of the sifter drive seal,

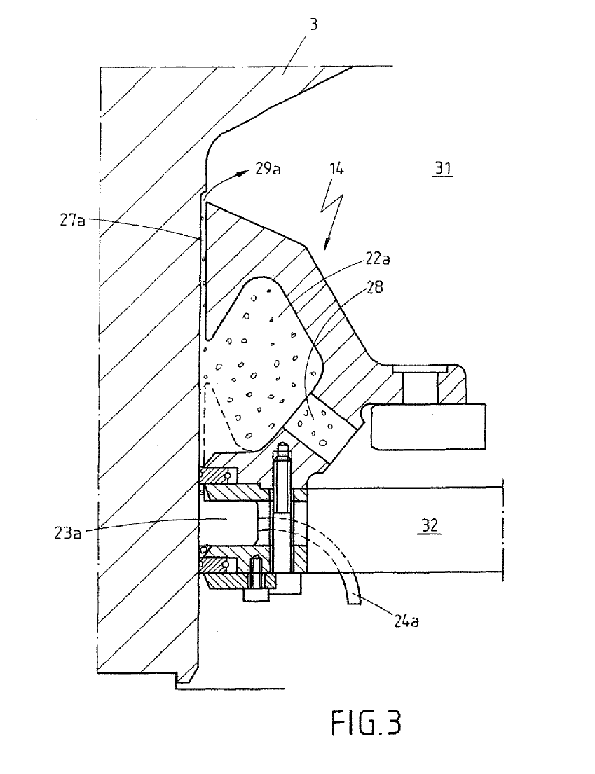

FIG. 3 shows a sealing gas seal in the region of the plinth bottom seal,

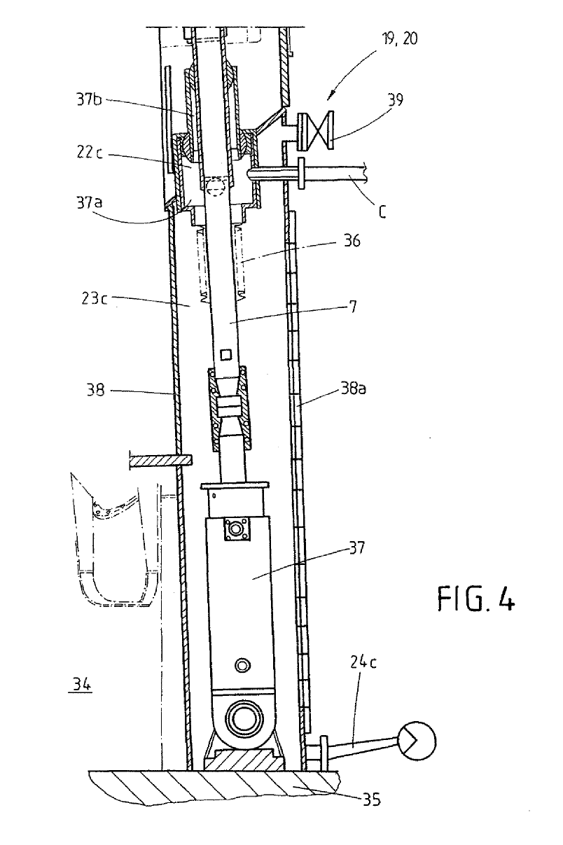

FIG. 4 shows a sealing gas seal in the region of the tie rod seal, and

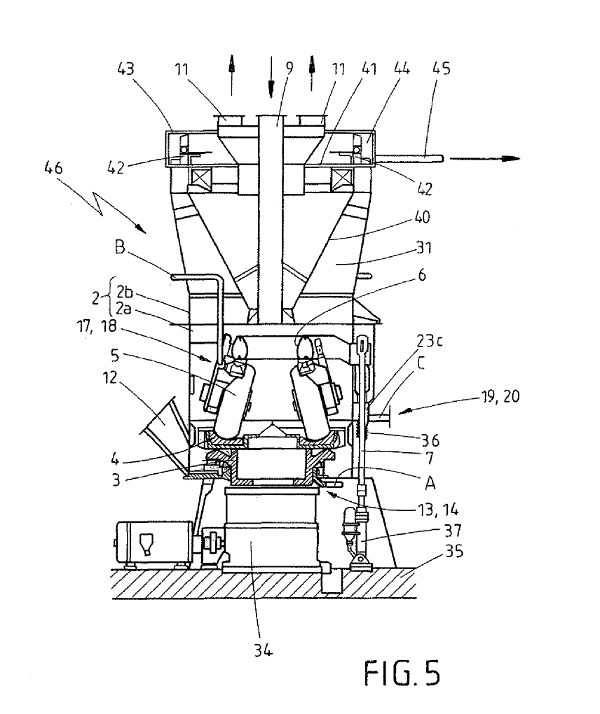

FIG. 5 shows a diagrammatic illustration of a roller mill with a static sifter.

The roller mill designated as a whole by 1 in FIG. 1, which is a coal mill, has a mill housing, designated as a whole by 2, which comprises the actual mill housing 2a and a sifter housing 2b. A rotating grinding table 4 is arranged on the bottom side on a grinding bowl carrier 3 in the mill housing 2a. Grinding rollers 5 lie as grinding tools on the rotating grinding table 4. The grinding rollers are pressed onto the grinding table 4 with the aid of a pressure frame 6 on which tie rods 7 engage. The grinding bowl carrier 3 is arranged on a gear 34 which, in turn, stands on a foundation 35. Arranged centrally in the upper region of the sifter housing 2b is a sifter 8 which is fastened, so as to rotate about a central grinding stock feed 9 in the form of a central grinding stock entry pipe, to the outside of the grinding stock feed 9 by means of a suspended mounting 10. Two grinding stock discharges 11 lead out of the sifter housing 2b. A carrier gas feed 12 is formed, level with the grinding bowl carrier 3, in the lower region of the mill housing 2a. The roller mill 1, when in its operating state, is supplied by the carrier gas feed 12 with CO₂-containing recirculated flue gas as carrier gas, in such a way that the mill 1 is operated in pressurized mode. Coal is applied through the grinding stock feed 9 centrally onto the grinding table 4 between the grinding rollers 5 and is moved outward toward the table margin by the rotating grinding table 4. In this case, the grinding stock passes under the grinding rollers 5 and is comminuted. The comminuted grinding stock is entrained by the carrier gas stream in the mill housing 2a and is carried upward to the sifter 8. Fine stock flows, together with the carrier gas, through the rotating sifter 8 and is discharged from the sifter housing 2b through the grinding stock discharges 11.

The roller mill 1 has a series of movable mill elements, such as, for example, the grinding table 4 with assigned grinding bowl carrier 3 and plinth bottom 32, the sifter 8 with assigned drive and assigned mounting, the grinding rollers 5 in each case with assigned mounting and assigned drive, and the tie rods 7 with elements movable in relation to one another.

So that no CO₂-containing carrier gas can emerge outward from the mill interior 31 during pressurized mode, the roller mill is provided with a sealing-off sealing gas seal 14 in the region of the plinth bottom seal 13 in which the mill housing 2a is sealed off downwardly by means of a bottom surface 32, the plinth bottom, between the grinding bowl carrier 3 and mill housing wall 33. The roller mill is likewise provided with a second sealing gas seal 16 in the region of the sifter drive seal 15. A third sealing gas seal 17 is formed and arranged in the region of the grinding roller seal 18 on each of the grinding rollers 5. Finally, a fourth sealing gas seal 19 is formed in the region of the tie rod seal 20. CO₂-containing recirculated flue gas is fed as sealing gas via a line 21 to all four sealing gas seals 14, 16, 18 and 20, the sealing gas of the sealing gas seal 14 of the plinth bottom seal 13 being supplied via a branch line A, that of the third sealing gas seal 17 of the grinding roller seal 18 being supplied via a branch line B, that of the fourth sealing gas seal 19 of the tie rod seal 20 being supplied via a branch line C and that of the second sealing gas seal 16 of the sifter drive seal 15 being supplied via a branch line D. In this case, the sealing gas is supplied at a pressure which is higher than the mill internal pressure during grinding operation, so that the CO₂-containing sealing gas supplied enters the mill interior 31 at a low flow velocity via flow paths formed as leakage orifices and thus prevents the likewise CO₂-containing carrier gas causing the overpressure in the mill interior from emerging via these possible leakage flow paths.

At least one sealing-off sealing gas seal, in the present case the second sealing gas seal 16 in the region of the sifter drive seal 15 and the sealing gas seal 14 in the region of the plinth bottom seal 13, has in this case two sealing chambers, to be precise, in each case, a first sealing chamber 22a, 22b and a second sealing chamber 23a, 23b. Furthermore, in each case a diversion in the form of a line 24a, 24b conducting away is arranged on the respective second sealing chamber 23a, 23b.

FIG. 2 shows diagrammatically a detail of the suspended mounting 10, by means of which a region 26, rotating about the grinding stock feed 9, of the sifter 8 is driven and mounted. Both a first sealing chamber 22b and a second sealing chamber 23b are formed and arranged along the sealing surface 27 for the purpose of sealing off a stationary part 25 with respect to the rotating and driving part 26. The first sealing chamber 22b is fed with recirculated CO₂-containing flue gas via a line 28 when the mill is being operated with a pressure higher in relation to the overpressure prevailing in the mill interior 31. The CO₂-containing sealing gas enters from the first sealing chamber 22 in the region of the sealing surfaces 27 and flows via flow paths in the direction of the arrow 29 into the interior of the mill housing 2. The first sealing chamber 22b is therefore the sealing chamber located nearest to the mill interior 31. However, the sealing gas also enters the gap between the sealing surfaces 27 from the first sealing chamber 22b in the opposite direction. Here, then, is arranged and formed in a second sealing chamber 23b which is located downstream with respect to the first sealing chamber 22b on account of the flow paths for the sealing gas, so that the sealing gas enters the second sealing chamber 23b from the gap between the sealing surfaces 27.

The second sealing chamber 23b constitutes, in terms of a flow connection to the mill interior 31, as compared with the first sealing chamber 22b, a remote second sealing chamber 23b which, however, is instead located nearest to the outside atmosphere on account of the further flow paths emanating from it. A sealing gas pressure that is lower in relation to the sealing gas pressure of the first sealing chamber 22b is set in the second sealing chamber 23b. The sealing gas contained in the second sealing chamber 23b is conducted out of the latter via the diverting line 24b. Since preferably a sealing gas pressure lower than or equal to the outside atmospheric pressure prevails in the second sealing chamber 23b, air is sucked into the second sealing chamber 23b from outside in the direction of the arrow 30. This, then, prevents the situation where sealing gas may escape outward from the second sealing chamber 23b. Instead, both the sealing gas supplied from the first sealing chamber 22b and the air sucked in from outside are conducted away by the diverting line 24b.

The sealing gas seal 17, illustrated in FIG. 3, which seals off the mill interior 31 in the region of the mill housing bottom 32, is effective in the same way. The first sealing chamber 22a there is fed at increased pressure with CO₂-containing recirculated flue gas which then enters the gap formed between the sealing surfaces 27a and then enters the mill interior in the direction of the arrow 29a. Once again, downstream of the first sealing chamber 22a, a second sealing chamber 23a is arranged, in which a lower sealing gas pressure than in the first sealing chamber 22a and, in particular, also less than or equal to the outside atmospheric pressure prevails. Here, then, if leakage orifices are present, outside air is likewise sucked into the second sealing chamber 23a and, in a mixture with the sealing gas which has entered from the first sealing chamber 22a, is conducted away through the diverting line 24a. Here, too, the first sealing chamber 22a is located nearer to the mill interior 31 than the second sealing chamber 23a with respect to the directional flow of the CO₂-containing sealing gas. The second sealing chamber 23a for sealing gas emerging from the first sealing chamber 22a is likewise located downstream and is arranged more remotely from the mill interior 31 with respect to a flow connection to the mill interior 31, but, instead, is located nearer to the outside atmosphere than the first sealing chamber 22a.

FIG. 4 shows a diagrammatic partial illustration of a fourth sealing gas seal 19 in the region of the tie rod seal 20, which is formed in the region of a bellows 36 through which the tie rod 7 is/are guided movably. The bellows 36 with sealing chamber regions 37a, 37b formed on it constitutes the first sealing chamber 22c of the fourth sealing gas seal 19 of the tie rod seal 20, through which the tie rod 7 or parts of the tie rod 7 is/are guided movably. The branch line C, through which the CO₂-containing sealing gas is fed to the first sealing chamber 22c, issues into the first sealing chamber 22c. Since the bellows 36, which outwardly seals off the first sealing chamber 22c and consequently leakage paths from the mill interior 31, may, for example, become porous with time and therefore cannot be described as being permanently leaktight, that part of the tie rod 7 which faces the foundation is enveloped, starting from this region of the bellows 36 and the first sealing chamber 22c, by a cylinder-like casing 38 by means of the tension cylinder 37 anchored on the foundation 35. The interior of the casing 38 forms a second sealing chamber 23c between the region of the first sealing chamber 22c and the foundation 35. At the foundation-side end of the second sealing chamber 23c, a diverting line 24c with a connected suction extraction device is arranged, so that CO₂-containing sealing gas emerging from the first sealing chamber 22c into the second sealing chamber 23c is suction-extracted and conducted away. So that, where appropriate, air can be supplied in a directed manner from outside, the second sealing chamber 23c is provided with a suction intake feed with a throttling possibility 39. The first sealing chamber 22c again constitutes the sealing chamber located nearest to the mill interior, and the second sealing chamber 23c constitutes the second sealing chamber 23c which is located downstream for sealing gas emerging from the first sealing chamber 22c and which is remote from the mill interior 31 with respect to a flow connection to the mill interior 31 and is located nearest to the outside atmosphere. In order, in the event of a fault, to allow access to the interior of the second sealing chamber 23c, the casing 38 is provided partially with a demountable wall element 38a which, after removal, exposes an orifice in the casing 38.

The roller mill 1 is one which is a component of a coal-fired power plant, in particular a hard coal-fired power station, operated on the basis of the oxyfuel process with CO₂ separation, the returned or recirculated carbon dioxide-containing flue gas fed through the line 21 being that of such a power station, the combustion chamber of which is supplied according to the oxyfuel process with oxygen, instead of air, for combustion. In this case, however, it is perfectly possible that an additional oxygen fraction is admixed to the original CO₂-containing flue gas before use as sealing gas. In this case, the sealing gas mass flow fed through the line 21 is preferably apportioned such that the second sealing gas seal 16 in the region of the sifter drive seal 15 is supplied with 36-44%, the sealing gas seal 14 in the region of the plinth bottom seal 13 is supplied with 27-33%, the third sealing gas seal 17 in the region of the grinding roller seal 18 is supplied with 21.5-26.5% and the fourth sealing gas seal 19 in the region of the tie rod seal 20 is supplied with 5.5-6.5% of the overall sealing gas mass flow fed to the roller mill 1.

The recirculated, preferably purified and dehumidified, CO₂-containing flue gas which is supplied from the coal-fired power station to the carrier gas feed 12 is likewise one which occurs in a coal-fired power station, the combustion chamber of which is supplied according to the oxyfuel process with oxygen, instead of air, for combustion. Here, too, an additional oxygen fraction can be supplied, prior to entry into the roller mill, to the flue gas forming the mill carrier gas or a mill carrier gas constituent. It is also possible, however, to use the roller mill and sealing gas seal according to the invention also in conventional standard power plants or those with coal gasification preceding the power station combustion chamber and to act upon it there with CO₂-containing flue gas which occurs. It is also possible, however, to use CO₂-containing gas or flue gas coming from other processes as sealing gas in the subject of the invention.

While the invention is explained above by the example of a roller mill 1 with a dynamic sifter 8, it is, of course, also possible to implement the invention in a roller mill 46 with a static sifter 40. Such a mill is illustrated in FIG. 5. Even though it is not stated in any more detail, this mill has all the features listed above with regard to the sealing gas seals provided and technical equipment features, with the one essential difference that a second sealing gas seal 16 is not present in the region of a sifter drive seal 15, since, in the case of the static sifter, a sifter drive is omitted. The elements and articles identical to the roller mill 1 are otherwise designated by the same reference symbols in FIG. 5 as in FIGS. 1-4.

Since, in a roller mill 46 with a static sifter 40, although the drive between the stationary grinding stock feed 9 (coal downpipe) and a rotatable sifter 8 is omitted, but instead, on the other hand, the upper housing cover 41 has a plurality of shafts 42 with passage through the housing cover 41 into the mill interior 31, which shafts may likewise form leakage orifices, a closed further casing 43 is formed above the upper housing cover 41 and provides a further casing chamber 44. Arranged on this casing chamber 44 is a diversion line 45 with connected suction extraction, which provides both the casing chamber 44 and the second sealing chamber 23c with a vacuum causing suction extraction, so that CO₂-containing leakage carrier gas emerging from passage orifices for the shafts 42 is intercepted by means of the casing chamber 44 and conducted away via the line 45. Sifter flaps of the static sifter 40 which are arranged in the mill interior 31 are arranged in each case on the shafts 42, so that a multiplicity of shafts 42 may be provided which are led outward through the upper housing cover 41. In order to cover this upper cover region completely, it is therefore expedient if a casing 43 is provided which is adapted to the outer mill contour, that is to say has wall regions virtually constituting extensions of the outer mill wall, and which in its inner region has clearances for leading through the grinding stock feed 9 and the grinding stock discharges 11.

1. A roller mill capable of operation in pressurized mode, said roller mill comprising:
a mill housing,
a rotating grinding table having grinding tools lying on the grinding table,
a grinding stock feed,
a sifter,
at least one grinding stock discharge,
at least one sealing gas seal sealing off the mill interior in the region of movable mill elements from the outside atmosphere, and
a carrier gas feed,
wherein
at least the at least one sealing gas seal includes:
a first sealing chamber and
a second sealing chamber,
the first sealing chamber being acted upon with a sealing gas having a sealing gas pressure that is increased in relation to the mill pressure prevailing in the mill interior while the mill is in operation, and
the second sealing chamber being acted upon with a sealing gas having a sealing gas pressure that is lower in relation to that of the sealing gas of the first sealing chamber, and
a diversion arranged on the second sealing chamber for conducting the sealing gas out of the second sealing chamber.

2. The roller mill as claimed in claim 1, wherein the sealing gas pressure of the second sealing chamber is less than or equal to atmospheric pressure.

3. The roller mill as claimed in claim 1, wherein the sealing gas of the first sealing chamber and/or of the second sealing chamber comprises recirculated carbon dioxide-containing (CO₂-containing) flue gas from a coal-fired power station, the combustion chamber of which is supplied according to the oxyfuel process with oxygen, instead of air, for combustion.

4. The roller mill as claimed in claim 1, wherein the sealing gas of the first and/or second sealing chamber comprises CO₂-containing flue gas with an admixed oxygen fraction (O₂ fraction).

5. The roller mill as claimed in claim 1, wherein
the first sealing chamber is located nearest to the mill interior, and
the second sealing chamber is located downstream for sealing gas emerging from the first sealing chamber, is remote from the mill interior with respect to a flow connection to the mill interior, and is located nearest to the outside atmosphere.

6. The roller mill as claimed in claim 1, wherein the roller mill further comprising a sealing gas seal in each case in the region of a plinth bottom seal and/or in the region of a sifter drive seal and/or in the region of a tie rod seal and/or in the region of a grinding roller seal, or the plinth bottom seal and/or the sifter drive seal and/or the tie rod seal and/or the grinding roller seal are/is designed in each case as a sealing gas seal.

7. The roller mill as claimed in claim 6, wherein the sealing gas fed to each sealing gas seal comprises recirculated CO₂-containing flue gas from a coal-fired power station, the combustion chamber of which is supplied according to the oxyfuel process with oxygen, instead of air, for combustion.

8. The roller mill as claimed in claim 6, wherein a sealing gas seal comprising the first and the second sealing chamber is formed in the region of the plinth bottom seal and/or in the region of the sifter drive seal and/or in the region of the tie rod seal and/or in the region of the grinding roller seal.

9. (canceled)

10. The roller mill as claimed in claim 1, wherein the carrier gas feed is line-connected to a flue gas line for recirculated CO₂-containing flue gas from a coal-fired power station, the combustion chamber of which is supplied according to the oxyfuel process with oxygen, instead of air, for combustion.

11. The roller mill as claimed in claim 1, further comprising a casing covering leadthroughs into the mill interior, and forming a casing chamber with a connected diversion line formed on an upper housing cover.

12. A method for operating a roller mill capable of operation in pressurized mode, said roller mill having a mill housing, a rotating grinding table having grinding tools lying on the grinding table, a grinding stock feed, a sifter, at least one grinding stock discharge, at least one sealing gas seal sealing off the mill interior in the region of movable mill elements with respect to the outside atmosphere, and a carrier gas feed, wherein at least the at least one sealing gas seal includes: a first sealing chamber and a second sealing chamber, the first sealing chamber being acted upon with a sealing gas having a sealing gas pressure that is increased in relation to the mill pressure prevailing in the mill interior while the mill is in operation, and the second sealing chamber being acted upon with a sealing gas having a sealing gas pressure that is lower in relation to that of the sealing gas of the first sealing chamber, and a diversion arranged on the second sealing chamber for conducting the sealing gas out of the second sealing chamber, said method comprising:
feeding, to at least one of the first and second sealing chambers, recirculated CO₂-containing flue gas from a coal-fired power station, the combustion chamber of which is supplied according to the oxyfuel process with oxygen, instead of air, for combustion, as sealing gas or a sealing gas constituent,
conducting the gas out of the second sealing chamber.

13. The method as claimed in claim 12, further comprising
supplying a first sealing gas seal designed in the region of or as a plinth bottom seal with 27-33% of the overall sealing gas mass flow fed to the roller mill,
supplying a second sealing gas seal designed in the region of or as a sifter drive seal with 36-44% of the overall sealing gas mass flow fed to the roller mill,
supplying a third sealing gas seal designed in the region of or as a grinding roller seal with 21.5-26.5% of the overall sealing gas mass flow fed to the roller mill, and
supplying a fourth sealing gas seal designed in the region of or as a tie rod seal with 5.5-6.5% of the overall sealing gas mass flow fed to the roller mill.

14. The method as claimed in claim 12, further comprising supplying, to the carrier gas feed, recirculated CO₂-containing flue gas from a coal-fired power station, the combustion chamber of which is supplied according to the oxyfuel process with oxygen, instead of air, for combustion, as a mill carrier gas or a mill carrier gas constituent.

15. The method as claimed in claim 12, further comprising intercepting and conducting away leakage gas emerging from leadthroughs by means of a casing chamber arranged on the upper housing cover and having a connected diversion line.

16. The method of claim 12, wherein supplying recirculated flue gas comprises supplying purified and dehumidified flue gas.

17. The roller mill of claim 11, wherein said casing covers leadthroughs for shafts.

18. The roller mill as claimed in claim 6, wherein the roller mill is a component of a hard coal-fired power station, operated on the basis of the oxyfuel process with CO₂ separation.

19. A coal-fired power plant comprising a roller mill capable of operation in pressurized mode, said roller mill comprising:
a mill housing,
a rotating grinding table having grinding tools lying on the grinding table,
a grinding stock feed,
a sifter,
at least one grinding stock discharge,
at least one sealing gas seal sealing off the mill interior in the region of movable mill elements from the outside atmosphere, and
a carrier gas feed,
wherein
at least the at least one sealing gas seal includes:
a first sealing chamber and
a second sealing chamber
the first sealing chamber being acted upon with a sealing gas having a sealing gas pressure that is increased in relation to the mill pressure prevailing in the mill interior while the mill is in operation, and
the second sealing chamber being acted upon with a sealing gas having a sealing gas pressure that is lower in relation to that of the sealing gas of the first sealing chamber, and
a diversion arranged on the second sealing chamber for conducting the sealing gas out of the second sealing chamber.

20. The coal-fired power plant of claim 19, wherein the plant further comprises a hard coal-fired power station configured for operation on the basis of an oxyfuel process with carbon-dioxide separation.
